(19) United States
(12) Patent Application Publication
(10) Pub. No.: US 2026/0348152 A1
(43) Pub. Date: Nov. 5, 2026

(54) ACOUSTIC DAMPENING DEVICE FOR AN ANECHOIC CHAMBER

(71) Applicant: Kidde-Fenwal, LLC, Ashland, MA (US)

(72) Inventor: Evan Wong, Ashland, MA (US)

(21) Appl. No.: 19/195,970

(22) Filed: May 1, 2025

(51) Int. Cl. E04B 1/84; A62C 3/02

(52) U.S. Cl. CPC E04B 1/84; A62C 3/0292; E04B 2001/8419

(57) ABSTRACT

An acoustic dampening device for use in an anechoic chamber includes a body and a sleeve. The body has an attachment surface, an absorbing surface, and a bore. The absorbing surface is opposite of the attachment surface and the bore has a first open end and a first closed end. The first open end is disposed at the attachment surface and the first closed end is closed by the body. The sleeve is disposed within the bore and includes a first end disposed at the attachment surface of the body and a second end disposed within the body. The first end of the sleeve is open.

### TECHNICAL FIELD

This disclosure relates to a fire suppression kit including an acoustic dampening device and an acoustic dampening device for use in an anechoic chamber.

### BACKGROUND

A conventional fire suppression system 100 for use in an anechoic chamber 102 is shown in FIG. 1. The conventional fire suppression system 100 includes at least one tank 104 coupled to a piping system 106. The tank 104 is configured to hold a fire suppression agent under pressure and may be opened or closed by a discharge valve 108. The piping system 106 fluidly connects the tank 104 to a nozzle 110 which is disposed at or adjacent to a wall 112 of the anechoic chamber 102. In such a manner, the conventional fire suppression system 100 is configured to provide the fire suppression agent from the wall 112 via the nozzle 110, thus distributing the fire suppression agent throughout the anechoic chamber 102.

A conventional anechoic chamber 102 includes acoustic dampening devices 114 configured to provide radio frequency (RF) shielding within the anechoic chamber 102 so as to preserve and maintain a suitable testing environment. For example, audio or radio equipment testing that may be performed within the anechoic chamber 102 requires RF shielding to ensure the test is executed correctly and as accurately as possible. In a conventional anechoic chamber 102 having a conventional fire suppression system 100, the nozzle 110 is disposed between acoustic dampening devices 114 so as to provide a path for the discharge of fire suppression agent to extinguish a fire. However, the with the nozzle 110 exposed between the acoustic dampening devices 114, in which case, noise is reverberated off of the nozzle and the efficiency of RF shielding within the anechoic chamber 102 and may be reduced.

Accordingly, it is desired to provide a fire suppression kit for an anechoic chamber that preserves RF shielding.

### SUMMARY

The disclosure relates to an acoustic dampening device for use in an anechoic chamber. The acoustic dampening device includes a body and a sleeve. The body includes a bore and an attachment surface disposed on a proximal end of the body. The bore has a first open end and a first closed end. The first open end is disposed at the attachment surface of the body and the first closed end is closed by the body. The sleeve is disposed within the bore and includes a first end disposed at the attachment surface of the body and a second end disposed within the body. The first end of the sleeve is open.

The acoustic dampening device may include one or more of the following aspects. For instance, the second end of the sleeve is closed.

In one configuration of the acoustic dampening device, the sleeve includes a flange extending radially from the first end and concentric to the first end.

In one configuration of the acoustic dampening device, the bore is cylindrical.

In one configuration of the acoustic dampening device, the sleeve is fixed within bore.

In one configuration of the acoustic dampening device, the body has a shape of one of a frustoconical, a conical, a prism and a pyramid.

In another aspect, a fire suppression kit for use in an anechoic chamber having a plurality of fixed acoustic dampening devices and a nozzle for delivering a fire suppression agent. The nozzle is spaced apart from the plurality of fixed acoustic dampening devices and extends from a wall of the anechoic chamber. The fire suppression kit includes a mount and an installed acoustic dampening device. The mount is configured to be attached to the wall and includes a cylindrical body having a through-bore extending through the cylindrical body. The cylindrical body is configured to receive the nozzle so as to allow the nozzle to release the fire suppression agent through the through-bore. The installed acoustic dampening device is configured to be slidably mounted onto the cylindrical body of the mount. The installed acoustic dampening device includes a body and a sleeve. The body has an attachment surface, an absorbing surface, and a bore. The absorbing surface is opposite of the attachment surface. The bore has a first open end and a first closed end. The first open end is disposed at the attachment surface and the first closed end is closed by the body. The sleeve is disposed within the bore and includes a first end disposed at the attachment surface of the body and a second end disposed within the body. The first end of the sleeve is open. The sleeve is configured to slide over the cylindrical body, wherein a discharge of the fire suppression agent pushes the installed acoustic dampening device off of the cylindrical body and releases the fire suppression agent into the anechoic chamber.

The fire suppression kit may include one or more of the following aspects. For instance, the second end of the sleeve is closed.

In one configuration of the fire suppression kit, the sleeve includes a flange extending radially from the first end and concentric to the first end.

In one configuration of the fire suppression kit, the mount includes a base disposed at a proximal end of the cylindrical body. The base is configured to be attached to the wall.

In one configuration of the fire suppression kit, the fire suppression kit further includes a tether. One end of the tether is fixed to the sleeve and the other end of the tether is fixed to the mount.

In one configuration of the fire suppression kit, a length of the cylindrical body is longer than a length between a distal end of the nozzle and the wall.

In another aspect, an anechoic chamber includes a plurality of walls, a ceiling, and a floor coupled together to enclose a space. The anechoic chamber further includes a plurality of acoustic dampening devices fixedly mounted to the wall, and a fire suppression system. The fire suppression system includes a canister for holding a fire suppression agent and a nozzle mounted to one of the plurality of walls and in fluid communication with the canister so as to discharge the fire suppression agent under pressure. One of the plurality of acoustic dampening devices is an installed acoustic dampening device. The installed acoustic dampening device is configured to cover the nozzle. The installed acoustic dampening device includes a body and a sleeve. The body has an attachment surface, an absorbing surface, and a bore. The absorbing surface is opposite of the attachment surface. The bore has a first open end and a first closed end. The first open end is disposed at the attachment surface and the first closed end is closed by the body. The sleeve is disposed within the bore and includes a first end disposed at the attachment surface of the body and a second end disposed within the body. The first end of the sleeve is open. The sleeve is slidably mounted over the nozzle, wherein a discharge of the fire suppression agent pushes the installed acoustic dampening device off of the nozzle and releases the fire suppression agent into the anechoic chamber.

The anechoic chamber may include one or more of the following aspects. For instance, the second end of the sleeve is closed.

In one configuration of the anechoic chamber, the sleeve is fixed within bore.

In one configuration of the anechoic chamber, the anechoic chamber further includes a mount configured to be attached to the wall. The mount includes a cylindrical body having a second open end. The cylindrical body is configured to receive the nozzle so as to allow the nozzle to release the fire suppression agent through the second open end. The sleeve is mounted over the cylindrical body. In a further configuration of the anechoic chamber, the mount includes a base disposed at a proximal end of the cylindrical body. The base is configured to be attached to the wall. In an even further configuration, the anechoic chamber further includes a tether. One end of the tether is fixed to the sleeve and the other end of the tether is fixed to the mount. In an even further configuration of the anechoic chamber, a length of the cylindrical body is longer than a length between a distal end of the nozzle and the wall. In another even further configuration of the anechoic chamber, the sleeve includes a flange extending radially from the first end and concentric to the first end. The flange is configured to be seated against the base of the mount.

### DESCRIPTION OF DRAWINGS

FIG. 1 is a schematic view of a conventional anechoic chamber including a conventional fire suppression kit;

FIG. 2 is a perspective view of a fire suppression kit according to one or more aspects described herein;

FIG. 3 is an exploded view of the fire suppression kit shown in FIG. 2;

FIG. 4 is a perspective view of a body of an acoustic dampening device of the fire suppression kit shown in FIG. 2;

FIG. 5 is a perspective view of a sleeve of the acoustic dampening device shown in FIG. 4;

FIG. 6 is a cross-sectional view of the fire suppression kit shown in FIG. 2;

FIG. 7 is a perspective view of the fire suppression kit shown in FIG. 2 including a tether;

FIG. 8 is a schematic view of an anechoic chamber including the fire suppression kit shown in FIG. 2.

FIG. 9A is a cross-sectional view showing the mount installed to an interior side of a wall; and

FIG. 9B is a cross-sectional view showing the mount installed to an exterior side of a wall.

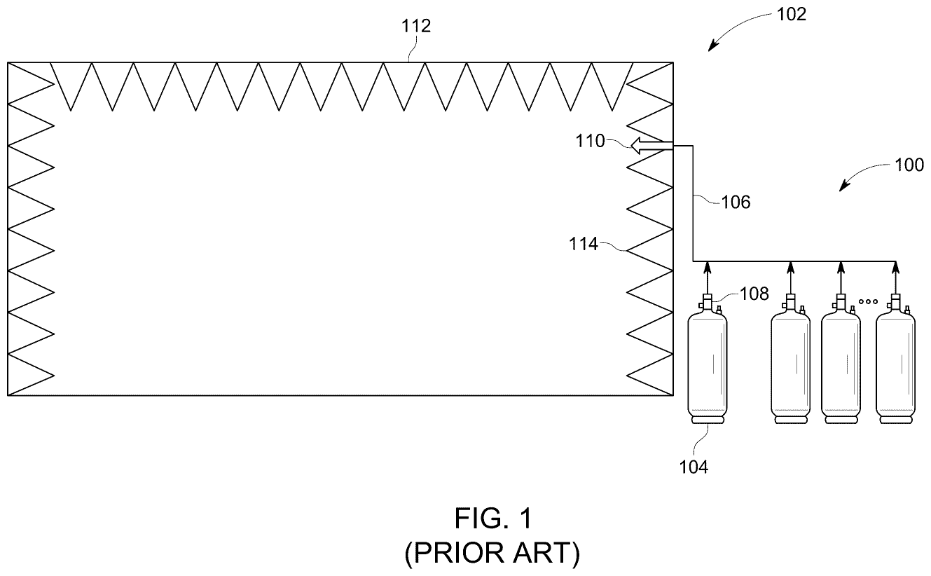

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

Directional terms as used herein—for example “up”, “down”, “right”, “left”, “front”, “back”, “top”, “bottom”—are made only with reference to the figures as drawn and are not intended to imply absolute orientation. As such, terms such as “upper”, “lower”, “height” and “width” are taken in context of the directional terms and the drawings.

An acoustic dampening device for use in an anechoic chamber is configured to maintain the acoustic properties of the anechoic chamber while providing fire suppression. The acoustic dampening device includes a body and a sleeve. The body has an attachment surface, an absorbing surface, and a bore. The absorbing surface is opposite of the attachment surface and the bore has a first open end and a first closed end. The first open end is disposed at the attachment surface and the first closed end is closed by the body. The sleeve is disposed within the bore and includes a first end disposed at the attachment surface of the body and a second end disposed within the body. The sleeve is configured to be slidably mounted over a nozzle and the first end of the sleeve is open. Thus, the acoustic dampening device may be slid over the nozzle upon a discharge of a fire suppression agent so as to allow the fire suppression agent to extinguish a fire. However, the acoustic dampening device covers the nozzle when a discharge event has not occurred so as to maintain the acoustic properties of the anechoic chamber.

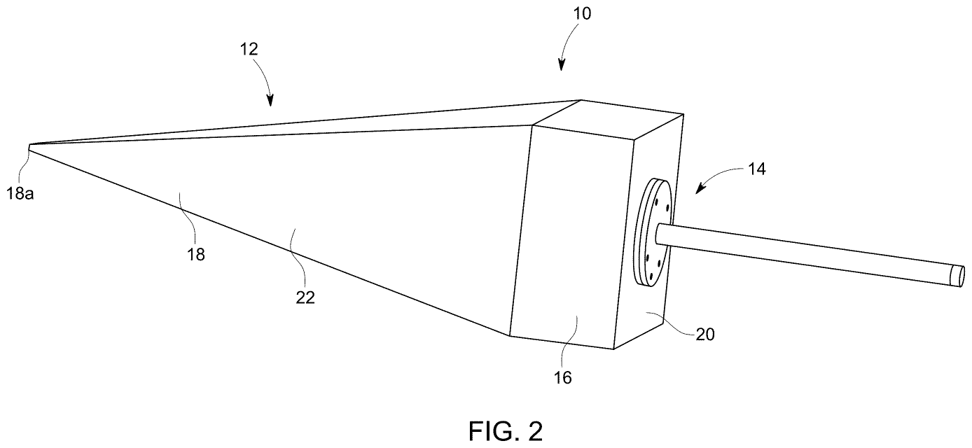

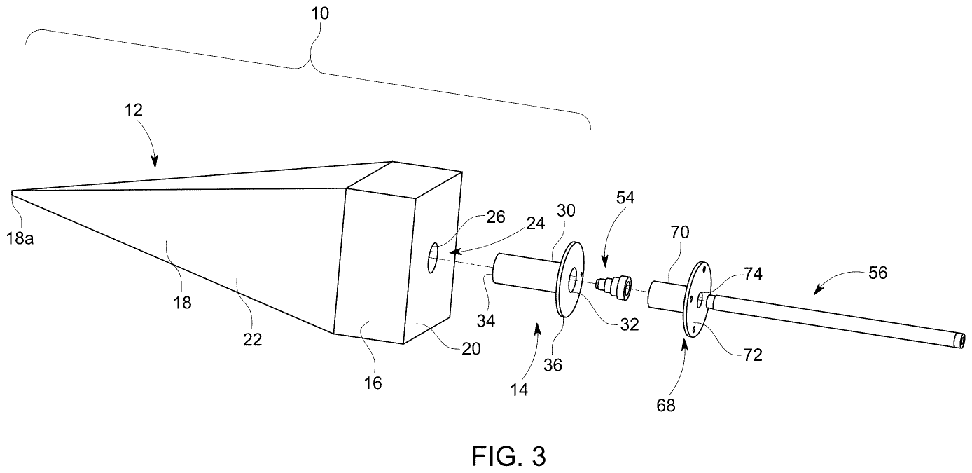

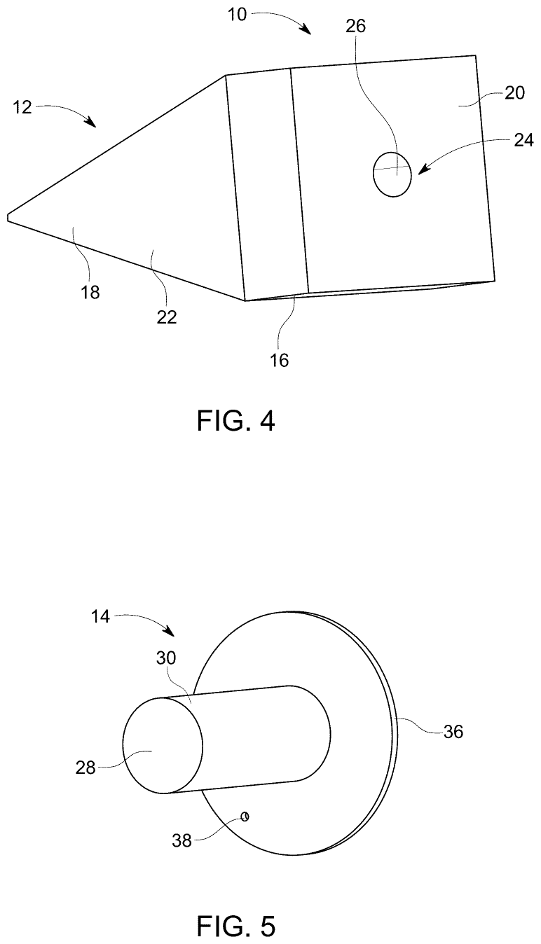

With reference to FIG. 2-4, an acoustic dampening device 10 is provided. The acoustic dampening device 10 includes a body 12 and a sleeve 14. The body 12 is formed of a material that may be configured to shield radio frequencies and absorb sound waves, such as high-density foam, fiberglass, glass wool, or something of the like. The body 12 includes an attachment portion 16 and an absorbing portion 18 extending from the attachment portion 16. As depicted in the provided figures, the body 12 is shaped as a four-sided polyhedron, or four-sided pyramid, wherein the attachment portion 16 is square-shaped and the absorbing portion 18 includes four lateral faces that extend between the attachment portion 16 and an apex 18a of the absorbing portion 18. However, it should be appreciated that the body 12 may be differently shaped without deviating from the scope of the appended claims. For example, the absorbing portion 18 may include three lateral faces and the attachment portion 16 may correspondingly be triangularly shaped, or the absorbing portion 18 may include more than four lateral faces with the attachment surface 20 shaped as a corresponding polygon. In another example, the body 12 may be conical wherein the absorbing portion 18 is curved and the attachment portion 16 is circular. In another aspect, the body 12 is frustoconical. In another example, the body 12 may be one of a variety of prism shapes that also lacks an apex. The specific shape of the body 12 may vary depending on its application.

In one aspect, the attachment portion 16 is integrally formed with the absorbing portion 18 and may be formed of the same material as the absorbing portion 18. In another aspect, the attachment portion 16 is formed as a separate piece and may be formed of the same material or a different material than the absorbing portion 18. The attachment portion 16 includes an attachment surface 20 formed on a distal end of the attachment portion 16. The attachment surface 20 may be a generally planar surface. The absorbing portion 18 has an absorbing surface 22 which defines an outer surface of the absorbing portion 18.

The body 12 includes a bore 24 having a first open end 26 and a first closed end 28 opposite of the first open end 26. The first open end 26 is open to the attachment surface 20 while the first closed end 28 is closed by the body 12. The bore 24 may extend along an axis that is perpendicular to the attachment surface 20 and extends into the body 12 between the first open end 26 and the first closed end 28. It should be appreciated that a diameter “D1” or cross-section of the bore 24 and a length of the bore 24 between the first open end 26 and the first closed end 28 may vary depending on its application without deviating from the scope of the appended claims. Further, while the bore 24 depicted in the figures is cylindrical, the bore 24 may be a square bore or any variety of polygon-shaped bore.

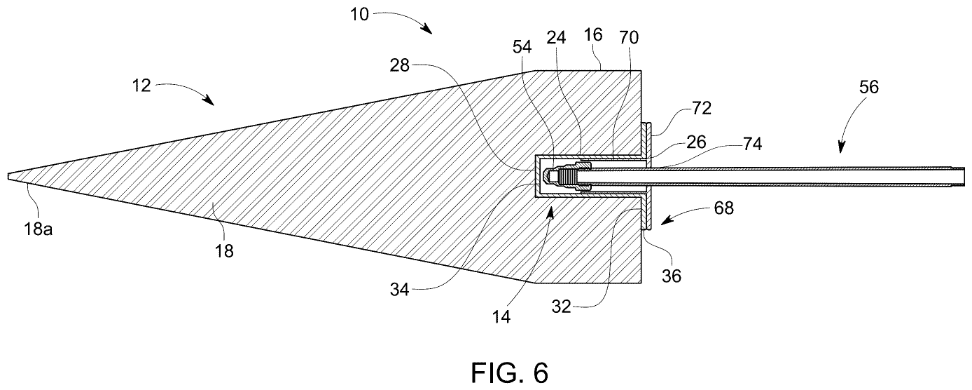

With continued reference to again to FIGS. 2-4, and now with reference to FIG. 5, the sleeve 14 of the acoustic dampening device 10 is disposed within the bore 24 of the body 12. The sleeve 14 is made of a durable and rigid material such as metal, composite, polymer such as acrylonitrile butadiene styrene (ABS) plastic, or something of the like. The sleeve 14 includes a sleeve body 30 extending between a first end 32 and a second end 34 opposite of the first end 32 wherein the first end 32 is open and the second end 34 may be open or closed. The first end 32 of the sleeve 14 is disposed at the attachment surface 20 of the body 12 and both the sleeve body 30 and the second end 34 of the sleeve 14 are entirely disposed within the bore 24. The sleeve 14 may be press-fit, mechanically attached, or otherwise fixed within the bore 24 of the body 12.

The outer surface of the sleeve body 30 is configured to be seated within the bore 24. As depicted in the provided figures, the sleeve body 30 is cylindrical and includes a diameter “D2” that is similar or slightly lesser than the diameter “D1” of the bore 24. This allows the sleeve 14 to be fully inserted into the bore 24 without obstruction or restriction. It should be appreciated that a differently shaped bore 24, such as a square bore as described above, necessitates the sleeve body 30 to be correspondingly shaped. Further, the sleeve body 30 includes a length between the first end 32 and the second end 34 that is equal to or lesser than the length of the bore 24. This allows the first end 32 of the sleeve 14 to be flush or near-flush with the attachment surface 20 of the body 12.

The sleeve 14 may include a flange 36 extending radially from the first end 32 and is concentric to the first end 32. A diameter “D3” of the flange 36 may be greater than the diameter “D1” of the bore 24 so as to prevent the sleeve 14 from being inserted into the bore 24 further than desired. In other words, the flange 36 is configured to be seated against the attachment surface 20 when the sleeve 14 is fully disposed within the bore 24. The flange 36 may also include one or more through-holes 38 extending through the flange 36. The through-holes 38 are configured to accept a mechanical fastener, such as a screw, a bolt, or something of the like, so as to mechanically attach the flange 36 to the attachment surface 20, fixing the sleeve 14 within the bore 24.

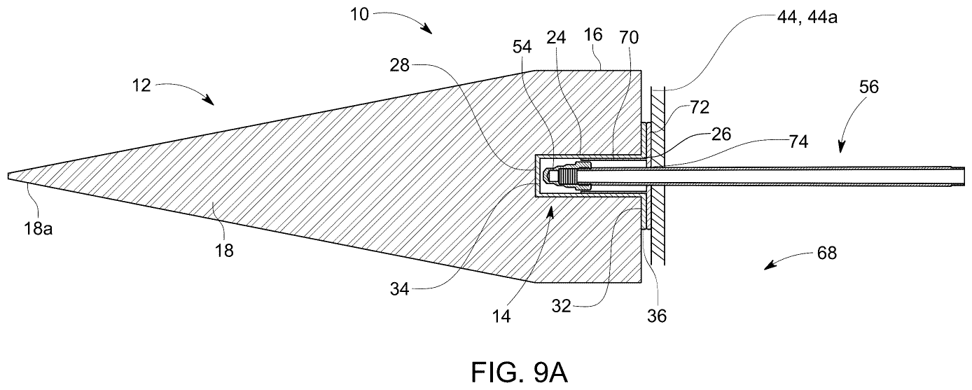

With reference to FIG. 8, an anechoic chamber 40 having a fire suppression system 42 is provided. The anechoic chamber 40 is configured to facilitate testing that requires suppression and absorption of sound waves, radio frequency waves, and the like. The anechoic chamber 40 includes a plurality of walls 44, a ceiling 46, and a floor 48 coupled together so as to enclose a space 50. It should be appreciated that the anechoic chamber 40 may be a room that is shaped and configured in a variety of ways without deviating from the scope of the appended claims. For example, the anechoic chamber 40 may include curved walls, partial partitions, or other varying configurations such as to accommodate the specific testing that occurs within the anechoic chamber.

The anechoic chamber 40 also includes plurality of the fixed acoustic dampening devices 52 some of which may be fixed to the walls 44, and/or the ceiling 46 of the anechoic chamber 40. The fixed acoustic dampening devices 52 are made of a material having a predetermined acoustic dampening characteristic(s) as described above and distinguishable from the acoustic dampening devices 10 described above in that they are generally solid body members. That is, the fixed acoustic dampening devices 52 do not have a bore and the attachment surface of the fixed acoustic dampening devices 52 is fixed to the wall 44 and/or ceiling 46 as the case may be.

The anechoic chamber 40 is shown as having fixed acoustic dampening devices 52 that cover the entire surface of the walls 44 and the ceiling 46, but it should be appreciated that the fixed acoustic dampening devices 52 need not necessarily cover the entire surface of the walls 44 and the ceiling 46 based upon the acoustic characteristics desired. Each of the fixed acoustic dampening devices 52 are disposed generally adjacent to one another and may be sized and shaped similarly or identically to each other or may differ in shape based upon. For example, each of the plurality of fixed acoustic devices 52 may be shaped in a frustoconical configuration, in a conical configuration, as a prism, or as a pyramid.

The fire suppression system 42 is configured to extinguish fires that may arise within the anechoic chamber 40. The fire suppression system 42 includes a nozzle 54, a piping system 56, at least one tank 58 and a discharge valve 60. The tank 58 may be disposed outside of the anechoic chamber 40 and is configured to hold a fire suppression agent under pressure. The piping system 56 fluidly couples the tank 58 to the nozzle 54. The discharge valve 60 is configured to open and close fluid communication from the tank 58 to the nozzle 54.

The nozzle 54 is disposed within the space 50 of the anechoic chamber 40 and is configured to discharge the fire suppression agent. Any nozzle 54 currently known or later developed may be modified for use herein. The nozzle 54 may be attached to a portion of the piping system 56 that extends through one of the walls 44 of the anechoic chamber 40 or the ceiling 46 as the case may be. For illustrative purposes, the anechoic chamber 40 is shown as having a single nozzle 54; however, it should be appreciated that the anechoic chamber 40 may include more than one nozzle 54 and the piping system 56 may include multiple portions extending through the walls 44 and/or ceiling 46 of the anechoic chamber 40, each of which has a nozzle 54 mounted thereto so as to provide multiple sources for the discharge of the fire suppression agent. The nozzle 54 is spaced apart from the fixed acoustic dampening devices 52 so as to provide a clear path for the discharge of the fire suppression agent

The fire suppression system may also include a fire control panel 62 and a detector 64 for detecting a fire or conditions for combustibility. The detector 64 may be disposed on the ceiling 46 or the wall 44 of the anechoic chamber 40 and sends a signal to the fire control panel 62 in the event a fire or a condition for combustibility is detected. The fire control panel 62 relays the signal or transmits a new signal to the discharge valve 60 so as to open fluid communication to the tank 58, thus allowing the fire suppression agent to exit the tank 58 and discharge through the nozzle 54.

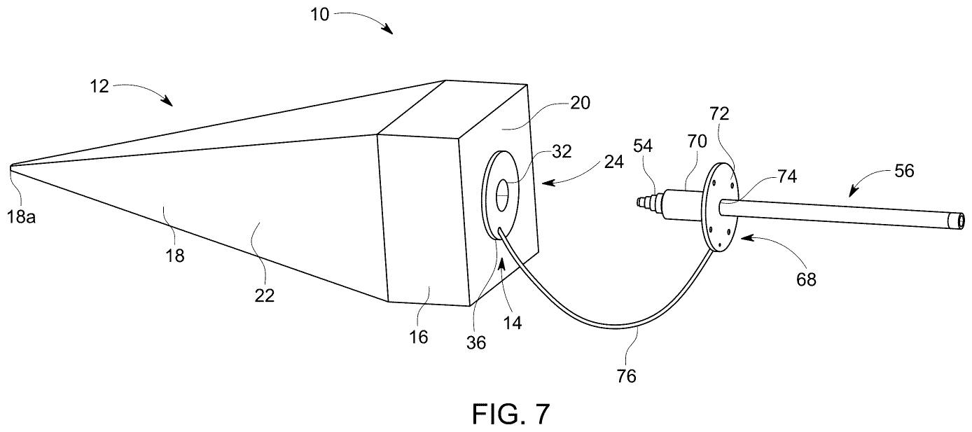

With reference to again to FIGS. 2-6, a fire suppression kit 66 is provided. The fire suppression kit 66 may be mounted to the anechoic chamber 40 and includes the acoustic dampening device 10, referenced herein as an installed acoustic dampening device 10a. The fire suppression kit 66 also includes a mount 68. The mount 68 includes a cylindrical body 70 and a base 72. The base 72 is disposed at a proximal end of the cylindrical body 70 and extends radially from the proximal end of the cylindrical body 70. The cylindrical body 70 has a through-bore 74 extending through the cylindrical body 70 so as to define open ends. The cylindrical body 70 and the base 72 may be configured as a single unit and is made of a durable and rigid material such as metal, polymer such as ABS plastic, or something of the like. The cylindrical body 70 has a diameter “D4” which is smaller than the diameter “D2” of the sleeve body 30 but sufficiently large enough to make contact with a substantial inner surface of the sleeve body 30 so as to hold the sleeve 14. It should be appreciated that the diameter “D3” of the cylindrical body of the mount 68 with respect to the diameter “D2” of the sleeve 14 is not to great so as to cause a friction fit between the sleeve 14 and the mount 68 which cannot be overcome by the pressure generated by the discharge of the fire suppression agent.

The mount 68 is configured to attach to one of the walls 44 and/or the ceiling 46 so as to enclose the sides of a nozzle 54 and to be seated within the bore 24 of the installed acoustic dampening device 10a. Thus, during a discharge operation of the pressure from the fire suppression agent pushes the acoustic dampening device off of the mount 68, exposing the nozzle 54 and providing a clear path for the discharge of fire suppression agent.

Referring again to FIGS. 2-9B, a description of the installation of the fire suppression kit 66 to the anechoic chamber 40 is provided. The mount 68 is placed over an exposed nozzle 54, wherein the base 72 is attached to a wall 44 and/or a ceiling. The base 72 may be fastened to the wall 44 and/or ceiling by using conventional fastening means, such as a bolt or a screw. Once the mount 68 is mounted, the installed anechoic dampening device 10a is mounted onto the mount 68. In particular, the sleeve 14 is configured to be mounted over the cylindrical body 70 of the mount 68. As the diameter “D4” of the cylindrical body 62 of the mount 68 is smaller than a diameter “D1” of the sleeve body 30, the installed acoustic dampening device 10a is simply slid onto the cylindrical body 70 of the mount 68 until the flange 36 of the sleeve 14 is seated against the base 72 of the mount 68. Thus, the nozzle 54 is covered by the installed acoustic dampening device 10 and acoustic waves are prevented from hitting the nozzle 54 and the acoustic characteristics of the anechoic chamber 40 is preserved. In the event of a fire or a combustible event, the pressure from the discharge of the fire suppression agent applies a load onto the second end 34 of the sleeve 14, which is closed, pushing the sleeve 14 off the mount 68 creating an unimpeded path for the discharge of the fire suppression agent. In aspects where the second end 34 of the sleeve 14 is open, the pressure from the discharge of the fire suppression agent applies a load onto the first closed end 28 of the bore 24 of the body 12 and the sleeve 14 is pushed off the mount 68.

As a result, the fire suppression kit 66 remains fully operational while maintaining desired suppression and absorption of sound waves, radio frequency waves, and the like, within the space 50 defined by the anechoic chamber 40. During operation of the fire suppression kit 66, a fire within the anechoic chamber 40 may be detected by the fire control panel. Detection of a fire opens the discharge valve 60 at the tank 58, thus enabling the flow of the fire suppression agent from the tank 58, through the piping system 56, and to the nozzle 54 under a pressure.

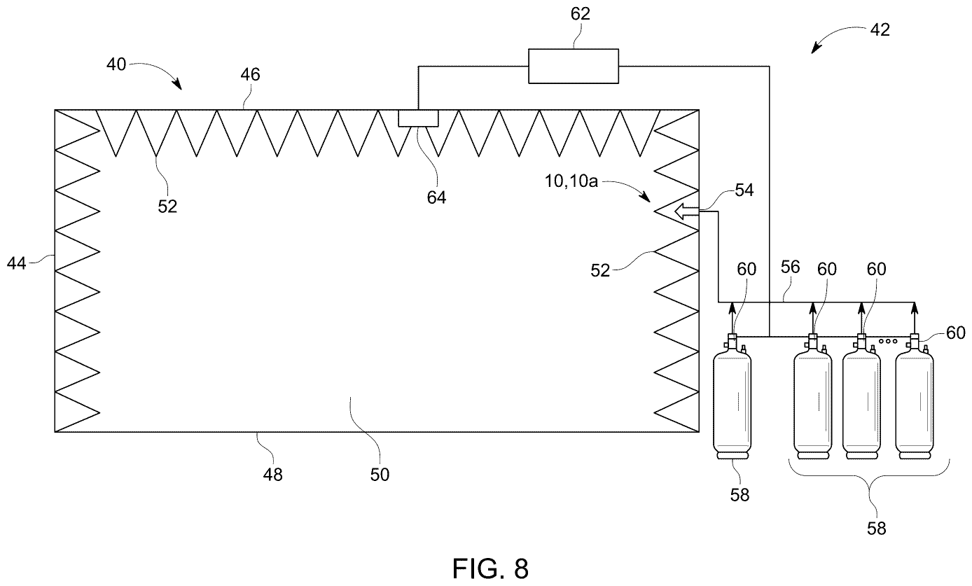

In some configurations, and as shown in FIG. 7, the fire suppression kit 66 includes a tether 78 configured to retain the acoustic dampening device 10. In one aspect, one end of the tether 78 is fixed to the sleeve 14 and the other end of the tether 78 is fixed to the mount 68. In another aspect, one end of the tether 78 is fixed to the sleeve 14 and the other end of the tether is fixed to the wall 44. The tether 78 retains the acoustic dampening device 10 near the mount 68 after the discharge of the fire suppression agent pushes the acoustic dampening device 10 off the cylindrical body 70 of the mount 68. The acoustic dampening device 10 may be reinstalled on the mount 68 after being released by the force of the fire suppression agent and after the fire suppression agent ceases being released by the nozzle 54.

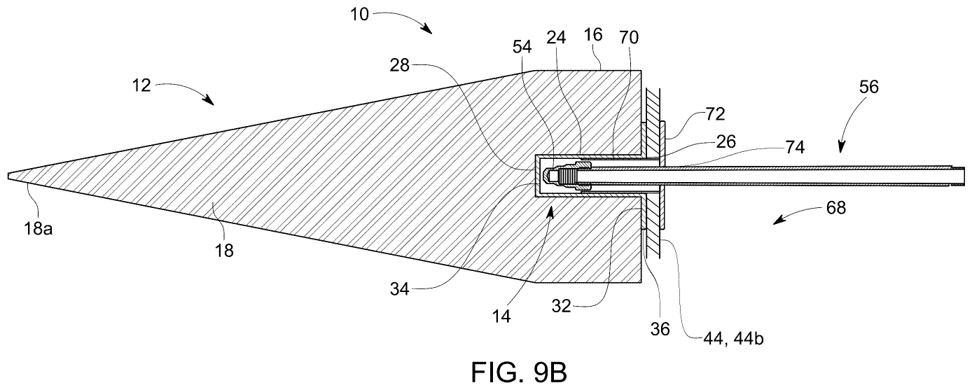

With reference now to FIG. 9A, the mount 68 is shown attached to an interior side 44a of the wall 44 using known attachment means such as a bolt or screw. The entirely of the mount 68 is disposed within the anechoic chamber 40. In such an aspect, the wall 44 includes a hole 78 extending through the wall 44 and having a diameter D4 configured to receive a portion of the piping system 56, and the nozzle 54 is disposed on a distal end of the piping system 56 so as to be disposed within the anechoic chamber 40. The mount 68 is disposed over over a portion of the nozzle 54 and the base 72 of the mount 68 is concentric to the hole 78 of the wall 44. The base 72 is fixed to the interior side 44a of the wall 44, wherein a discharge of the fire suppression agent 14 pushes off the mount 68 creating an unimpeded path for the discharge of the fire suppression agent. In aspects where the fire suppression kit 66 includes a tether 76, the tether 76 is fixed to the sleeve 14 on one end and the mount 68 on the other end.

With reference now to FIG. 9B, the mount 68 is shown attached to an exterior side 44b of the wall 44. In such an aspect, the wall 44 includes a hole 78 extending through the wall 44 and having a diameter D4 configured to receive the cylindrical body 70 of the mount 68. The base 72 of the mount 68 is concentric to the hole 78 of the wall 44 and fixed to the exterior side 44b of the wall 44 using known attachment means, such as a bolt or a screw. The cylindrical body 70 extends from the interior side 44a of the wall 44 so as to place the nozzle 54 within the anechoic chamber 40. In aspects where the fire suppression kit 66 includes a tether 76, the tether 76 is fixed to the sleeve 14 on one end and the inner side of the wall 44a the other end.

As such, the anechoic chamber 40 may incorporate the fire suppression kit 66 without encumbering or negatively impacting the desired suppression and absorption of sound waves, radio frequency waves, and the like, within the space 50.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An acoustic dampening device for use in an anechoic chamber, the acoustic dampening device comprising:
a body having an attachment surface, and a bore, the attachment surface disposed on a proximal end of the body, the bore having a first open end and a first closed end, wherein the first open end is disposed at the attachment surface and the first closed end is closed by the body; and
a sleeve disposed within the bore, wherein the sleeve includes a first end disposed at the attachment surface of the body and a second end disposed within the body, wherein the first end is open.

2. The acoustic dampening device as set forth in claim 1, wherein the second end of the sleeve is closed.

3. The acoustic dampening device as set forth in claim 1, wherein the sleeve includes a flange extending radially from the first end and concentric to the first end.

4. The acoustic dampening device as set forth in claim 1, wherein the bore is cylindrical.

5. The acoustic dampening device as set forth in claim 1, wherein the sleeve is fixed within bore.

6. The acoustic dampening device as set forth in claim 1, wherein the body has a shape of one of a frustoconical, a conical, a prism and a pyramid.

7. A fire suppression kit for use in an anechoic chamber including a plurality of fixed acoustic dampening devices and a nozzle for delivering a fire suppression agent, the nozzle spaced apart from the plurality of fixed acoustic dampening devices and extending from a wall of the anechoic chamber, the fire suppression kit comprising:
a mount configured to be attached to the wall, the mount including a cylindrical body having a through-bore extending through the cylindrical body, the cylindrical body configured to receive the nozzle so as to allow the nozzle to release the fire suppression agent through the through-bore; and
an installed acoustic dampening device configured to be slidably mounted onto the cylindrical body of the mount, the installed acoustic dampening device including:
a body having an attachment surface, an absorbing surface and a bore, the absorbing surface opposite of the attachment surface, the bore having a first open end and a first closed end, the first open end is disposed at the attachment surface and the first closed end is closed by the body; and
a sleeve disposed within the bore, wherein the sleeve includes a first end disposed at the attachment surface of the body and a second end disposed within the body, wherein the first end is open; and
wherein the sleeve is configured to slide over the cylindrical body, wherein a discharge of the fire suppression agent pushes the installed acoustic dampening device off of the cylindrical body and releases the fire suppression agent into the anechoic chamber.

8. The fire suppression kit as set forth in claim 7, wherein the second end of the sleeve is closed.

9. The fire suppression kit as set forth in claim 7, wherein the sleeve includes a flange extending radially from the first end and concentric to the first end.

10. The fire suppression kit as set forth in claim 7, wherein the mount includes a base disposed at a proximal end of the cylindrical body, the base configured to be attached to the wall.

11. The fire suppression kit as set forth in claim 7, further including a tether, wherein one end of the tether is fixed to the sleeve and the other end of the tether is fixed to the mount.

12. The fire suppression kit as set forth in claim 7, wherein a length of the cylindrical body is longer than a length between a distal end of the nozzle and the wall.

13. An anechoic chamber comprising:
a plurality of walls, a ceiling and a floor coupled together to enclose a space;
a plurality of acoustic dampening devices fixedly mounted onto the wall;
a fire suppression system including a tank for holding a fire suppression agent and a nozzle mounted to one of the plurality of walls and in fluid communication with the tank so as to discharge the fire suppression agent under pressure;
wherein one of the plurality of acoustic dampening devices is an installed acoustic dampening device, the installed acoustic dampening device configured to cover the nozzle, the installed acoustic dampening device including:
a body having an attachment surface, an absorbing surface and a bore, the absorbing surface opposite of the attachment surface, the bore having a first open end and a first closed end, the first open end is disposed at the attachment surface and the first closed end is closed by the body; and
a sleeve disposed within the bore, wherein the sleeve includes a first end disposed at the attachment surface of the body and a second end disposed within the body, wherein the first end is open; and
wherein the sleeve is mounted over the nozzle, wherein a discharge of the fire suppression agent pushes the installed acoustic dampening device off of the nozzle and releases the fire suppression agent into the anechoic chamber.

14. The anechoic chamber as set forth in claim 13, wherein the second end of the sleeve is closed.

15. The anechoic chamber as set forth in claim 13, wherein the sleeve is fixed within bore.

16. The anechoic chamber as set forth in claim 13, further including a mount configured to be attached to one of the plurality of walls, the mount including a cylindrical body having a second open end, the cylindrical body configured to receive the nozzle so as to allow the nozzle to release the fire suppression agent through the second open end, wherein the sleeve is mounted over the cylindrical body.

17. The anechoic chamber as set forth in claim 16, wherein the mount includes a base disposed at a proximal end of the cylindrical body, the base configured to be attached to the wall.

18. The anechoic chamber as set forth in claim 17, further including a tether, wherein one end of the tether is fixed to the sleeve and the other end of the tether is fixed to the mount.

19. The anechoic chamber as set forth in claim 16, wherein a length of the cylindrical body is longer than a length between a distal end of the nozzle and the wall.

20. The anechoic chamber as set forth in claim 17, wherein the sleeve includes a flange extending radially from the first end and concentric to the first end, the flange configured to be seated against the base of the mount.
